(19) United States
(12) Patent Application Publication
(10) Pub. No.: US 2017/0038241 A1
(43) Pub. Date: Feb. 9, 2017

(54) Ring Clamp Level Sensor and Method of Use

(71) Applicant: Rayotek Scientific, Inc., San Diego, CA (US)

(72) Inventor: William Raggio, Del Mar, CA (US)

(21) Appl. No.: 15/229,918

(22) Filed: Aug. 5, 2016

Related U.S. Application Data
(60) Provisional application No. 62/202,490, filed on Aug. 7, 2015.

(51) Int. Cl. G01F 23/38

(52) U.S. Cl. CPC G01F 23/38

(57) ABSTRACT

A sensor has an insert configured to be arranged in a bore of a tubular section. The insert has a float with a magnetic material. The float may pivot within the insert in accordance with whether a fluid is present in bore of the tubular section. An outer ring is configured to be arranged around the tubular section. The outer ring has a portion including a switch moveable between open and closed positions. A spring is configured to maintain the switch in one of the open and closed positions. A magnetic portion is operatively connected to the switch. The magnetic portion of the switch cooperates with the magnetic material in the float in a manner to move the switch between the open and the closed positions against pressure of a biasing member based upon a position of the magnetic material relative the magnetic portion of the switch.

### RELATED APPLICATION DATA

This application claims the benefit of provisional application Ser. No. 62/202,490, filed on Aug. 7, 2015, the disclosure of which is incorporated by reference herein.

### BACKGROUND AND SUMMARY

The present disclosure relates to a ring clamp sensor for measuring fluid level in a pipe, or a vessel, for instance through a fitting installed on the vessel. The ring clamp sensor has an outer ring that is configured to encircle a pipe or a fitting associated with a vessel, and a magnetic float insert that is configured to be disposed in the pipe or the fitting and circumscribed by the outer ring. The outer rinf may comprise several arcuate sections that are assemblable together to form the outer ring. A portion of the outer ring has a switch with a magnetic portion that cooperates with the magnetic float insert to sense fluid level. The magnetic sensor activates when the fluid level reaches a limit and sends an electrical signal that may be used to provide an indication of level condition, for instance, a fluid fill or fluid drain condition.

### BRIEF DESCRIPTION OF THE FIGURES

FIG. 1 is a perspective view of an exemplary magnetic float insert of the ring clamp sensor.

FIG. 2 is a side view of the magnetic float insert of FIG. 1.

FIG. 3 is a sectional view of the magnetic float insert along lines 2-2 of FIG. 2.

FIG. 4 is a rear view of the magnetic float insert of FIG. 1.

FIG. 5 is a sectional view of the magnetic float insert along lines 4-4 of FIG. 4.

FIG. 6 is an enlarged view of the magnetic float insert from detail area 3-3 of FIG. 3.

FIG. 7 is an enlarged view of the magnetic float insert from detail area 5-5 of FIG. 5.

FIG. 8 are views of the magnetic float insert being arranged in a fitting comprising a pipe plug or pipe sight glass.

FIG. 9 are views of the magnetic float insert being arranged in a pipe or tube.

FIG. 10 is an illustrative implementation of the embodiment of FIG. 8 and shows a front view of the pipe fitting with the magnetic float insert arranged in the pipe fitting and a sensor portion of the outer ring arranged around the top of the fitting so as to provide sensor activation when fluid fills the fitting.

FIG. 11 is a side cross-sectional view of the arrangement of FIG. 10.

FIG. 12 is a front view of the arrangement of FIG. 10 with a support portion of the outer ring attached to the sensor portion of the outer ring.

FIG. 13 is a side cross-sectional view of the arrangement of FIG. 12.

FIG. 14 is illustrative implementation of the embodiment of FIG. 9 and shows a front view of the pipe fitting with the magnetic float insert arranged in the pipe and a sensor portion of the outer ring arranged around the bottom of the pipe so as to provide sensor activation when fluid drains from the pipe.

FIG. 15 shows a side cross-sectional view of the arrangement of FIG. 14.

FIG. 16 is a front view of the arrangement of FIG. 14 with a support portion of the outer ring attached to the sensor portion of the outer ring.

FIG. 17 is a side cross-sectional view of the arrangement of FIG. 16.

FIG. 18 is another illustrative implementation of the embodiment of FIG. 8 and shows a front view of a pipe fitting with the magnetic float insert arranged in the pipe fitting without fluid in the fitting which allows the magnetic float to move to the lowered position diametrically away from the sensor portion of the outer ring.

FIG. 19 is a side cross-sectional view of the arrangement of FIG. 18.

FIG. 20 is a further illustrative implementation of the embodiment of FIGS. 18 and 19, and shows a front view of the pipe fitting when fluid fills the fitting and forces the float of the magnetic float insert to a raised position adjacent to the sensor portion of the outer ring during sensor activation.

FIG. 21 is a side cross-sectional view taken along lines 20-20 of FIG. 20 and also illustrates use of an externally placed magnet and manipulation thereof to move the float of the magnetic float insert with the purpose of cleaning the inside of the window when a sight glass fitting is used.

FIG. 22 is another illustrative implementation of the embodiment of FIG. 9 and shows a front view of a pipe with the magnetic float insert arranged in the pipe and an outer ring arranged around the pipe without a fluid in the pipe so that float is in the lowered position.

FIG. 23 is a side cross-sectional view of the arrangement of FIG. 22.

FIG. 24 is further illustrative implementation of the embodiment of FIGS. 21 and 22, and shows a front view of a pipe when fluid fills the pipe and forces the float of the magnetic float insert to a raised position adjacent to the sensor portion of the outer ring during sensor activation.

FIG. 25 is a side cross-sectional view taken along lines 24-24 of FIG. 24.

FIG. 26 provides detail of a sensor portion and a support portion comprising the outer ring of the ring clamp sensor.

FIG. 27 is a side view of the outer ring of FIG. 26.

FIG. 28 shows is a cross-sectional view of the outer ring and shows an internal cavity of the sensor portion and a connection of the support portion to the sensor portion to form the outer ring.

FIG. 29 is an enlarged view from detail area 28-28 of FIG. 28 and shows one embodiment of electrical circuitry associated with the sensor portion of the outer ring with a switch in the cavity of the sensor portion in an open position prior to sensor activation.

FIG. 30 shows the embodiment of FIG. 28 during sensor activation.

FIG. 31 is an enlarged view from detail area 30-30 of FIG. 30 and shows the switch disposed in the cavity of the sensor portion of the outer ring in the closed position during sensor activation.

FIG. 32 is an enlarged view from a detail area similar to 30-30 of FIG. 30 but with alternate embodiment of the switch configuration of FIG. 28.

FIG. 33 is an enlarged view from a detail area similar to 30-30 of FIG. 30 but with another alternate embodiment of the switch configuration of FIG. 28.

### DETAILED DESCRIPTION

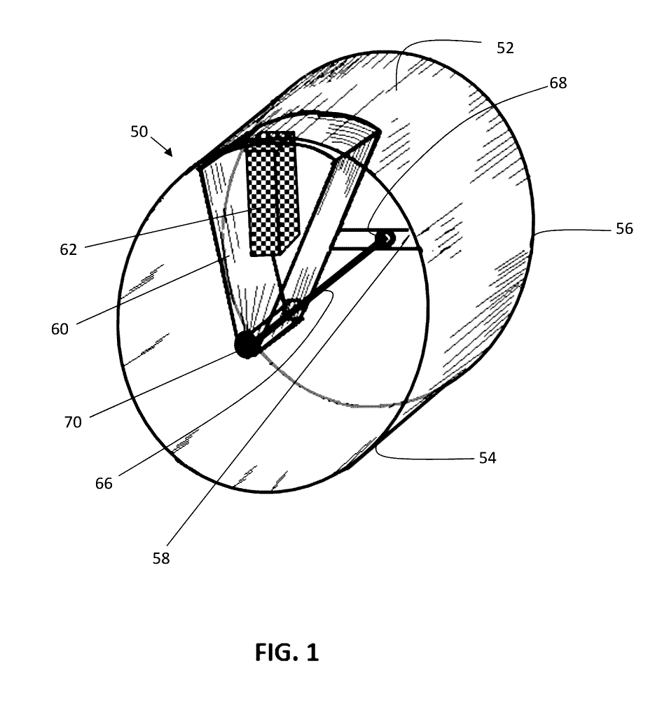

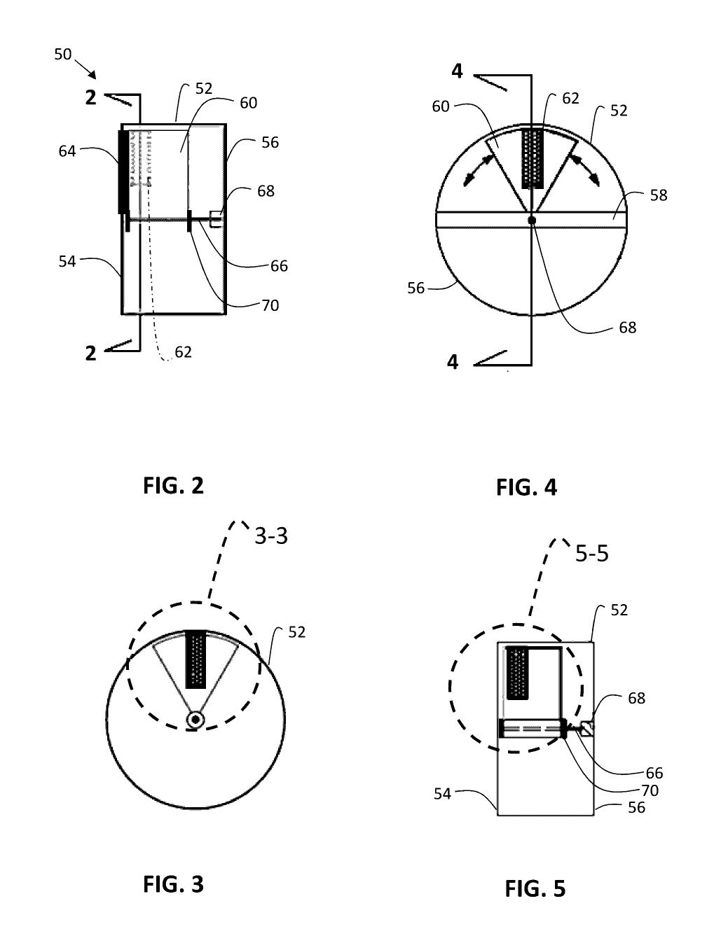

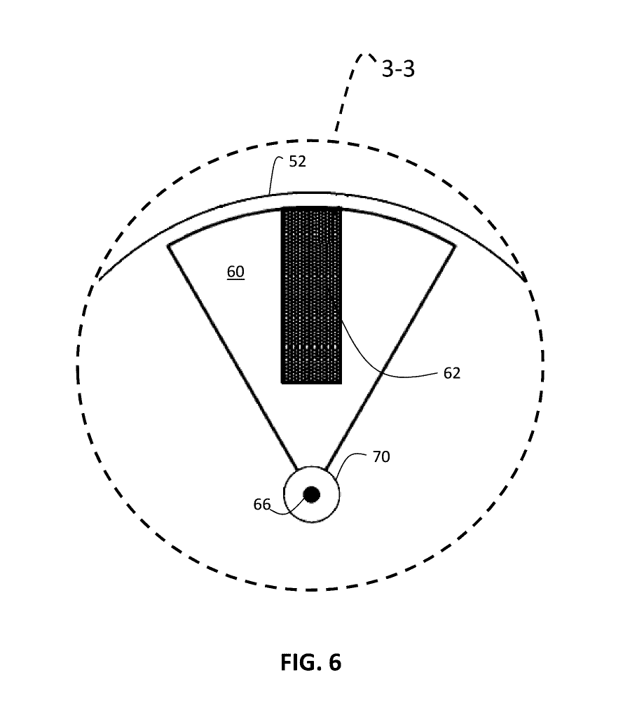

FIGS. 1-7 provide detail of a magnetic float insert 50 for the ring clamp level sensor. The magnetic float insert 50 comprises a housing 52 with a cylindrical outer diameter surface with axially opposite open sides 54,56. The cylindrical outer diameter surface defines a hollow interior of the housing 52 for the magnetic float insert. Circular edges of the housing at the opposite axial sides 54,56 of the housing define openings into the hollow interior of the housing. A band 58 extends across the diameter of the rear axial side 56 of the housing 52 and allows communication of the interior of the housing with an interior of the pipe or fitting in which the magnetic float insert is arranged. In one arrangement as described below in greater detail, the edges defining the opening at the front axial side 54 may directly contact or abut a window comprising a sight glass fitting when the magnetic float insert is arranged therein. In another arrangement as described below in greater detail, the openings on the axial sides 54,56 of the housing allow flow through, or to the interior of pipe or fitting in which the magnetic float insert is arranged. The housing may be made of metal, plastic or other rigid material. Dimensions of the cylinder comprising the housing 52 may be sized in order to allow the magnetic float insert to be housed securely (e.g., press-fit, snug-fit, glued, staked, mounted, etc) in the bore of a pipe plug type fitting, sight glass fitting, or a tube or pipe.

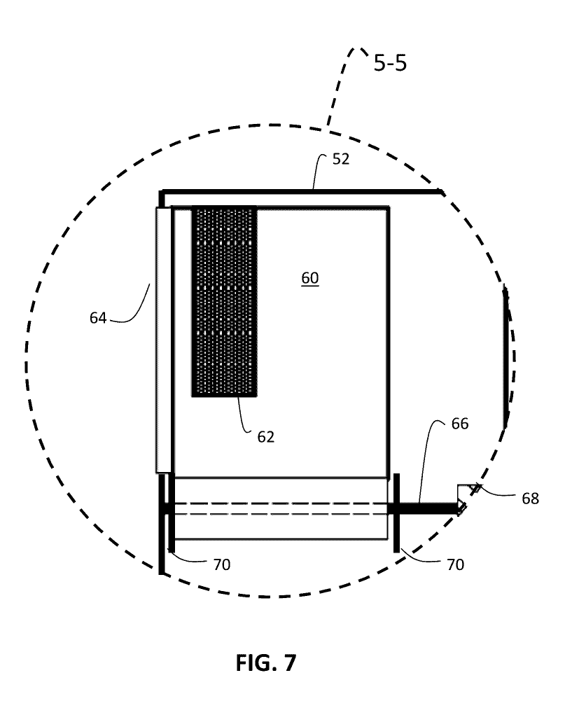

A float 60 may be disposed in the hollow interior of the housing 52 of the magnetic float insert and may be constrained to move between a position corresponding to a fluid fill position and a fluid drain position. The float may have a magnetic material 62 embedded within its interior. The float may be a hollow member or may be made of a material having a density less than the fluid with which it comes in contact. The float may also be made from materials that are impervious and inert to the fluid with which it comes in contact. For instance, the float may be made from foam or a chemically-resistant material such as Teflon, nickel, or stainless steel. The float may also be made of a material with low magnetic susceptibility to prevent interference with the magnetic material embedded therein. The float 60 may be generally pie-shaped and conform to the interior of the cylindrical housing 52, and the magnetic material 62 may be embedded in the float close to the outer peripheral surface of the float. As shown in FIG. 7, the float 60 may be provided with a cleaning pad 64 and may be axial offset in the interior of the housing 52 toward the front axial side 54, and the pad may extend slightly through the opening so that the pad may abut the backside window of a sight glass fitting into which the magnetic float insert is inserted. The amount of extension of the pad through the front axial side opening allows the pad to sufficiently engage the backside window for cleaning without unduly restricting movement of the float. As will be described in greater detail below, the float may be manipulated in order to allow cleaning of the backside window of a sight glass fitting using the pad of the float.

The band 58 extends across the rear edges of the opposite axial side 56 of the cylindrical housing 52 of the magnetic float insert. The band 58 may extend across a diameter of the housing or a short arc segment of the housing. The band 58 may be operatively connected to the float 60 to allow movement of the float between the fluid fill position and the fluid drain position. The band 58 may form a location point for an axle 66 upon which the float pivots 60 within the hollow interior of the housing. For instance, the axle 66 may be connected to the band 58 at a rigid axle support 68 and project into the interior of housing. The float 60 may have the shape of a wedge with the apex of the wedge comprising the pivot and the arcuate section of the wedge rotating within an interior of the cylindrical housing. The axle extending from the band may also have a connection to a rigid axle support on the opposite front axial face of the cylindrical housing (not shown). The axle may extend into the housing along a center axis of the housing. The float may pivot on the axle between the fluid fill position and the fluid drain position. The band may also have a connection to the float to allow the float to translate (i.e., move linearly) rather than pivot between the fluid fill position and the fluid drain position. There may be a minimal gap between the float 60 and the interior of the housing 52 to allow sensor activation from the magnetic material 62 embedded in the float. There may be a bearing or bushing disposed between the axle and the float to permit free rotation of the float on the axle during pivoting motion. There may be stops 70 on the axle to maintain the axial position of the float on the axle within the interior of the housing.

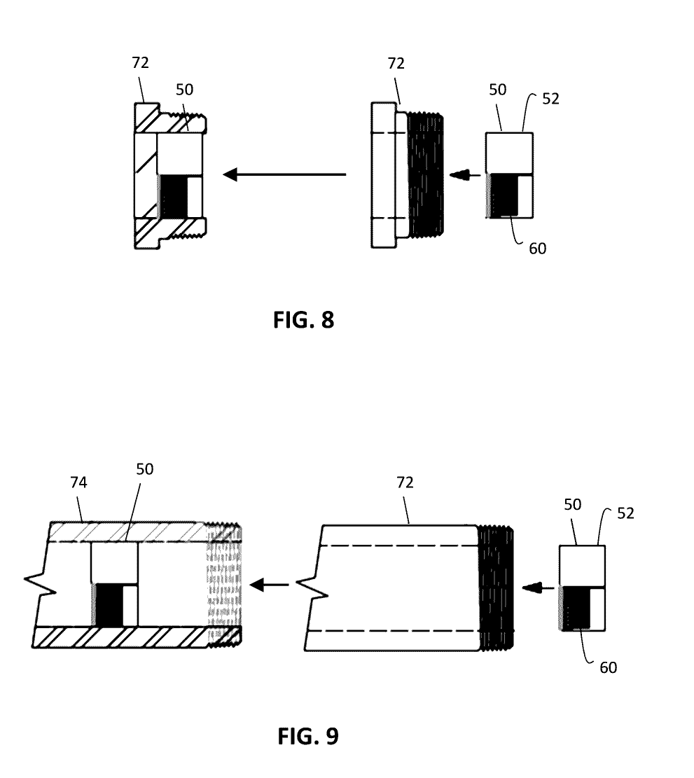

FIGS. 8 and 9 show alternate embodiments in which the magnetic float insert 50 may be arranged. In FIG. 8, the magnetic float insert 50 may be arranged in a pipe sight glass type fitting 72. The magnetic float insert may also be arranged in a pipe plug fitting. Such an arrangement would be similar to FIG. 8, but the fitting would be formed of metal, plastic, or other rigid material, and not have a viewing window on its face. FIG. 9 shows an alternate embodiment where the magnetic float insert 50 is inserted into the bore of a pipe or tube 74. In both embodiments of FIGS. 8 and 9, the cylindrical housing 52 of the insert is sized and designed to fit snuggly into the fitting, pipe or tube. The housing may also be tack welded, press fit, or secured with adhesive when fixed into the fitting or pipe. As shown in the embodiments of FIGS. 8 and 9, the float 60 pivots to a lowered position within the hollow interior of the housing 52 in the absence of a fluid. Upon the introduction of a fluid into the pipe or pipe fitting, the float pivots inside the cylindrical housing to an upward position. Depending upon the type of fluid level detection desired (i.e., a fluid filled indication or a fluid drained indication), the outer ring may be configured as described in greater detail below to provide sensor activation in the desired position.

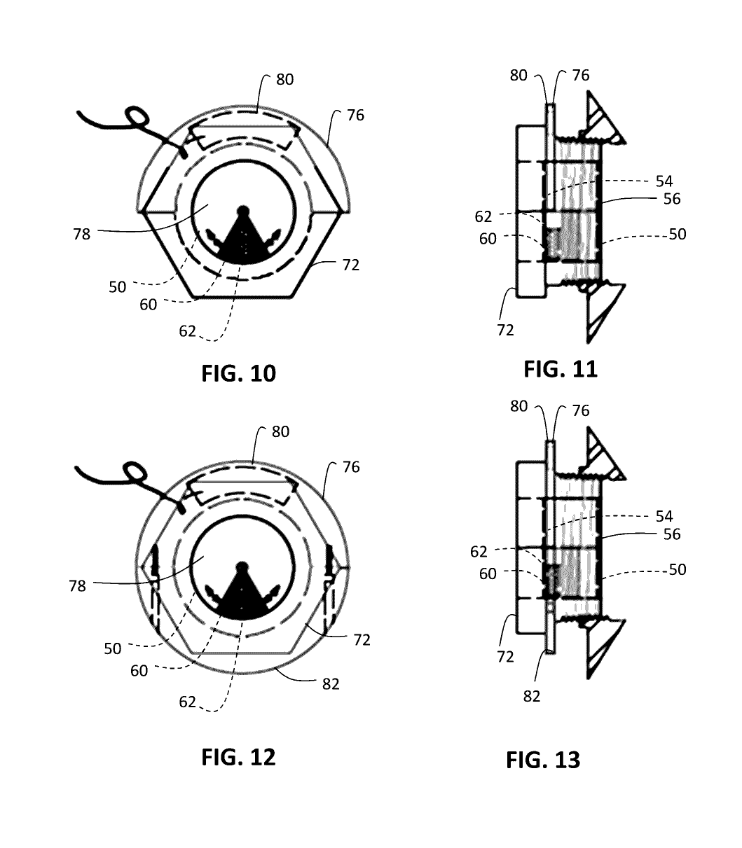

FIGS. 10-13 show the steps of installing an outer ring 76 to cooperate with the magnetic float insert 50 to detect a fluid filled condition. The outer ring 76 may comprise a plurality of arcuate sections that are assemblable to form the outer ring. In the embodiment shown in FIGS. 10-13, the magnetic float insert 50 is arranged in the pipe plug 72 such that the front axial opening 54 of the magnetic float insert abuts the backside window 78 of the pipe sight glass fitting and the float 60 is viewable from the window. Also, in FIGS. 10-13, the magnetic float insert 50 is arranged in the fitting such that in the normal position in the absence of fluid, the float 60 pivots to the lowered position as shown. An arcuate section 80 of the outer ring with a sensor portion is arranged on an upper arcuate portion of the fitting 72 diametrically away from the float 60 when the float is in the lowered (fluid drain) position. An arcuate section 82 of the outer ring with a support portion may be arranged around the lower arcuate portion of the fitting 72 and secured to the arcuate section 80 with the sensor portion so that the outer ring is firmly mounted around the fitting. As shown in FIGS. 12 and 13, the outer ring 76 is secured in place around the pipe fitting 72 with the sensor portion 80 of the outer ring clamp arranged diametrically away from the float 60 of the magnetic float insert. When fluid enters the fitting and fills the housing of the magnetic float insert 50, the float 60 will pivot in the housing to the fluid fill position where the magnetic material embedded 62 in the float comes in close proximity to a sensor housed in the sensor portion 80 of the outer ring, thereby activating the sensor. While the arrangement of FIGS. 10-13 shows the magnetic float insert arranged in a pipe plug fitting, the magnetic float insert may be similarly arranged in a pipe, for instance, a pipe as shown in FIG. 9.

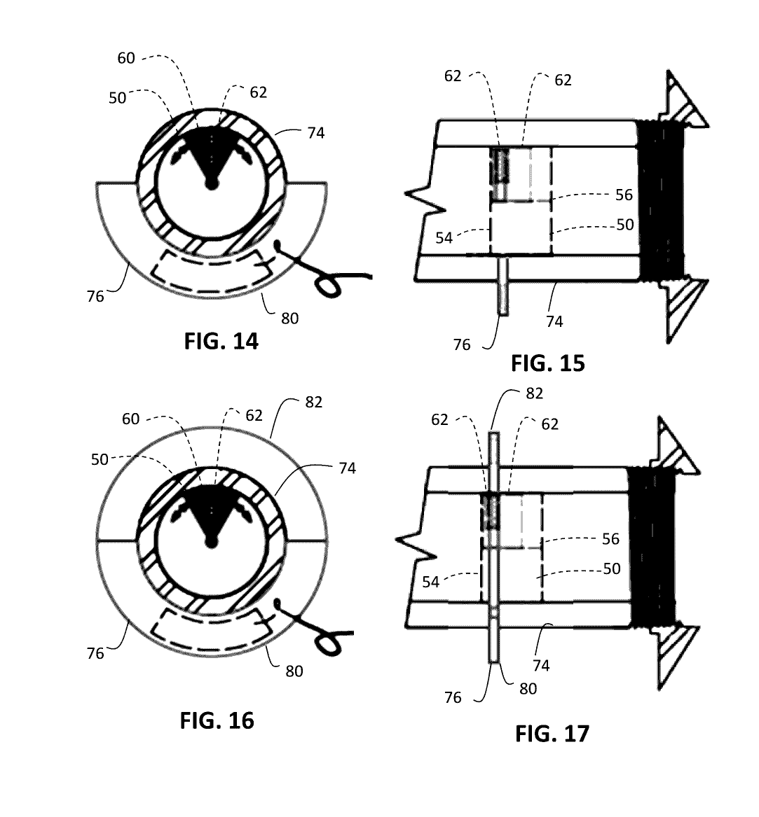

FIGS. 14-17 show an alternate embodiment of the steps of installing the outer ring to cooperate with the magnetic float insert 50 to detect a fluid drained condition in the pipe 74. In the configuration shown in FIGS. 14-17, the magnetic float insert 50 is arranged in the pipe 74 such that in the normal position when fluid is present in the pipe, the cylindrical housing of the magnetic float insert fills with fluid and maintains the float 60 in the upward position. The arcuate section 80 of the outer ring clamp with the sensor portion may be positioned diametrically away from the float 60 on the lower arcuate portion of the pipe 74. The arcuate section 82 of the outer ring with the support portion 82 may be arranged around the upper arcuate portion of the pipe 74 and secured to the sensor portion 80 so that the outer ring 76 is firmly mounted around the pipe. When fluid drains from the pipe 74 and out of the housing of the magnetic float insert 50, the float 60 will pivot in the housing to the fluid drain position where the magnetic material embedded 62 in the float comes in close proximity to the sensor housed in the sensor portion 80 of the outer ring, thereby activating the sensor. While the arrangement of FIGS. 14-17 shows the magnetic float insert arranged in a pipe, the magnetic float insert may be similarly arranged in a pipe fitting, for instance, a pipe fitting as shown in FIG. 8.

It should be appreciated that the arrangements shown in FIGS. 10-17 work optimally when the float of the magnetic float insert pivots on a generally horizontal plane. If the pivot axis is angled, then the float's motion may not correspond to the fluid level or may hinder the smooth rotation of the float on the axle.

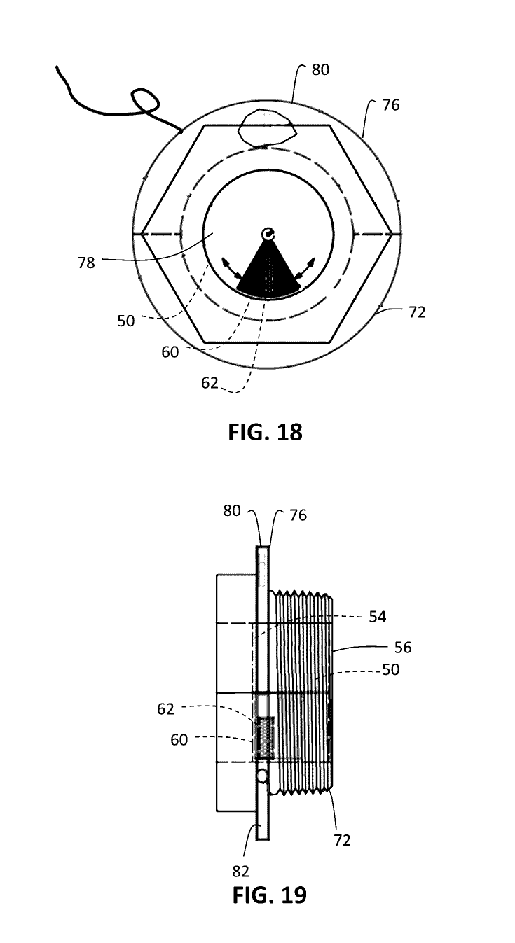

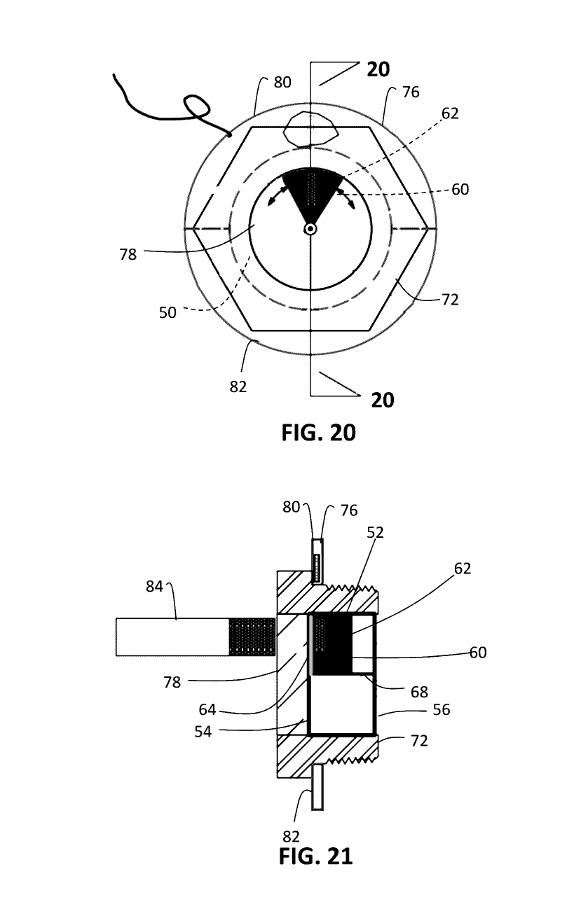

FIGS. 18-23 show an embodiment of the ring clamp level sensor wherein the magnetic float insert 50 is arranged in a pipe plug fitting 72 so that the sensor is activated upon a fluid fill condition. In FIGS. 18-19, the float 60 is shown in the fluid drained and normal position (i.e., lowered position) and FIGS. 20-21 show the float 60 in the fluid fill position, thereby activating the sensor. Because the float is pivotally connected to the float axle inside the cylindrical housing, the float always maintains the desired position as the pipe plug fitting with magnetic float insert is threaded into a fixture.

Making reference to FIG. 21, the front axial opening 54 of the cylindrical housing 52 of the magnetic float insert 50 may abut the backside window 78 of the pipe sight glass fitting 72 such that the float 60 is viewable through the pipe sight glass fitting window. To enable the viewing sight glass window 78 to be cleaned, the float 60 of the magnetic float insert may have a pad 64 on its front located at the front axial end 54 opening of the cylindrical housing. To clean the sight glass window backside, a magnet 84 may be brought adjacent to the front of the sight glass window 78 so that the float 60 may be manipulated, for instance, oscillated between the lowered and upper positions, to enable cleaning of the viewing window. In addition, the pad 64 will naturally clean the window 78 as the fluid level goes up and down, causing the pad the rub against the sight glass window backside, effectively cleaning it.

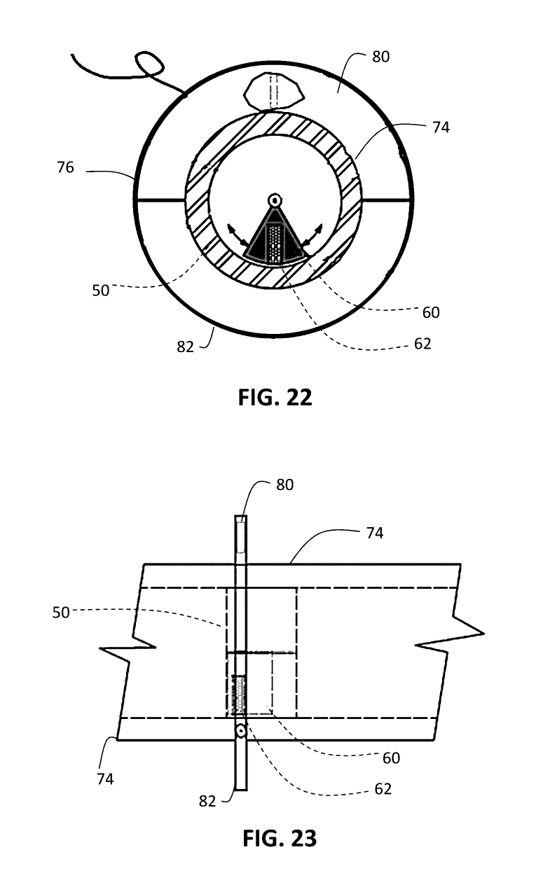

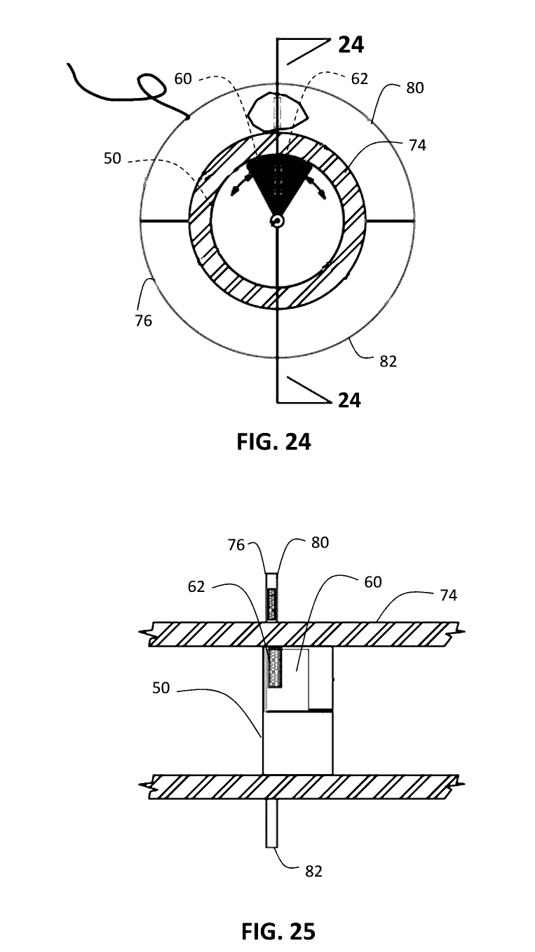

FIGS. 22-25 show an embodiment of the ring clamp level sensor wherein the magnetic float insert 50 is arranged in the pipe 74 so that the sensor is activated upon a fluid fill condition. In FIGS. 22-23, the float 60 is shown in the fluid drained and normal position (i.e., lowered position) and FIGS. 24-25 show the float 60 in the fluid filled position, thereby activating the sensor.

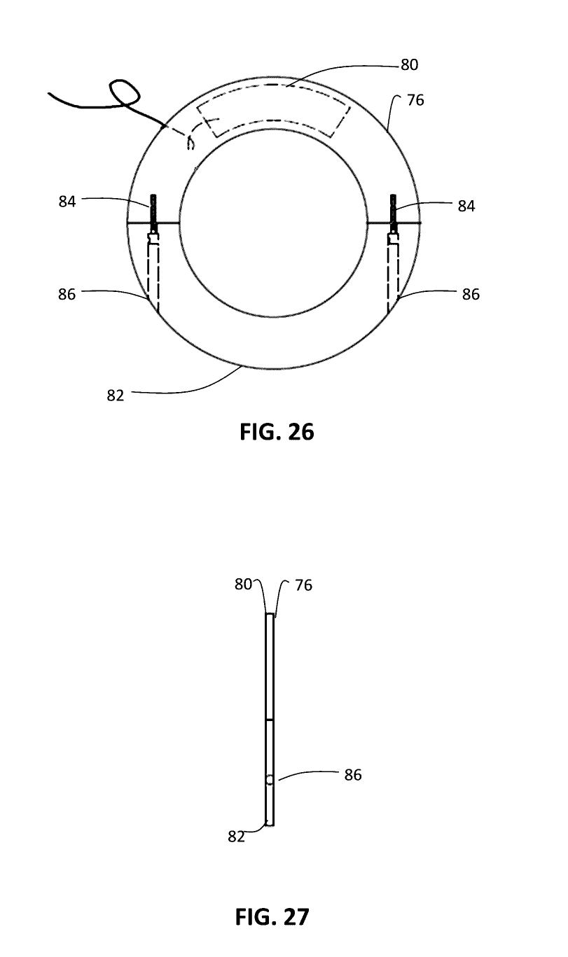

Referring to FIGS. 26 and 27 and as described previously, the outer ring 76 of the ring clamp may comprise a plurality of arcuate sections 80,82 that may be assemblable together. While the drawings show a semi-circular (i.e., 180 degree) shape sections, other shaped sections may be used for instance, six 60 degree sections, four 90 degree sections, three 120 degree sections. One or more of the arcuate sections may comprise the support portion 82 and one of the arcuate sections may comprise the sensor portion 80. The support portion 82 may have mechanical fasteners 84 directed through pilot holes 86 to allow it to be joined to the sensor portion 80 to form the outer ring 76 which may be arranged around the outer diameter of a pipe or a pipe plug fitting. A band may also be used around the outer periphery of the arcuate sections to hold the section around the pipe or pipe fitting.

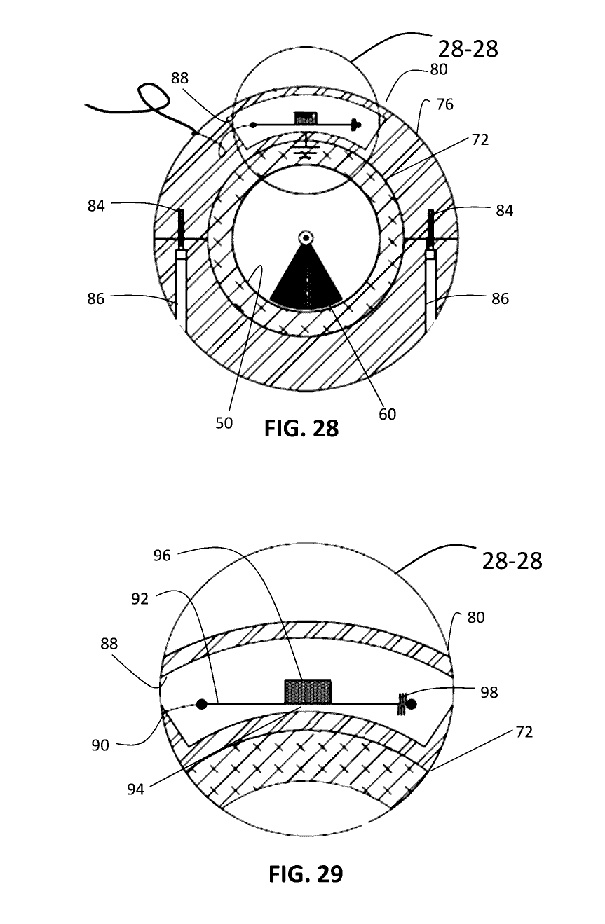

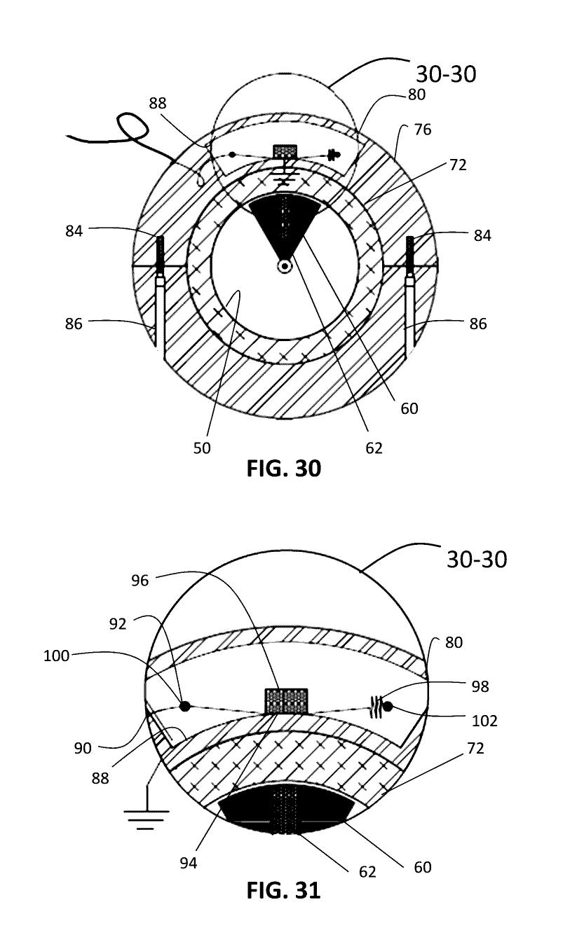

FIGS. 28-33 show various embodiments of sensor activation associated with the ring clamp level sensor. While the drawings show sensor activation relative to the magnetic float insert 50 installed in the fitting 72, similar principles may employed in connection with the magnetic float insert installed in the pipe 74. The arcuate section comprising the sensor 80 may have a sensor cavity 88 in which electrical circuit components are provided to generate the desired electrical signals. The electrical circuit may be configured to operate in a simple manner utilizing interior surfaces of the sensor cavity 88 of the sensor portion 80 of the outer ring and/or associated connections (e.g., the pipe, the fitting) to complete the electrical circuit. While in FIGS. 28-33 the interior surfaces of the sensor cavity are shown as a ground connection, a separate or dedicated ground connection may be provided.

FIGS. 28-31 shows one embodiment where the cavity 88 of the sensor portion 80 includes a power lead 90 that delivers electrical energy to a contactor 92 of a switch 94. The contactor 92 may have a magnetic portion 96 which is drawn into contact with ground (e.g., a ground wire or the interior surfaces of the sensor portion cavity) from the magnetic force of the magnetic material 62 embedded in the float 60 when the float comes in proximity to the magnetic portion of the contactor. The switch 94 may be configured to be in a normally open position and to move to a closed position due the magnetic attraction between the magnetic portion 96 of the contactor 92 and the magnetic material embedded 62 in the float 60 when the two are in close proximity. A biasing member 98 may urge the switch 94 to the normally open position as desired. The contactor 92 has a proximal end which is fixed to a first pin 100 and a distal end connected to a second pin 102 with the biasing member 98. The magnetic portion 96 of the contactor is centrally located on the contactor 92 in the cavity 88 at a distance from the interior surface of the sensor cavity. When the magnetic material 62 embedded in the float 60 comes in close proximity to the magnetic portion 96 of the contactor 92, the magnetic portion of the contactor is drawn toward the float, and the central portion of the contactor moves in a radial direction relative to the outer ring against the tension of the biasing member into electrical contact with the interior surfaces of the cavity of the sensor portion, thereby closing the switch to complete the electrical circuit. The biasing member 98 enables the contactor to deflect radially away from the interior surfaces of the cavity 88 when the magnetic material 62 embedded in the float 60 moves away from a position in close proximity to the magnetic portion of the contactor, thereby breaking electrical contact and opening the circuit. The magnetic attraction between the magnetic material 62 embedded in the float 60 and the magnetic portion 96 of the contactor 92 once the float comes in close proximity to the magnetic portion of the contactor may be sufficient to overcome the biasing force of the biasing member to allow the switch 94 to move from the open position to the closed position and then allow the switch to return to the open position when the float moves away from the magnetic portion of the contactor.

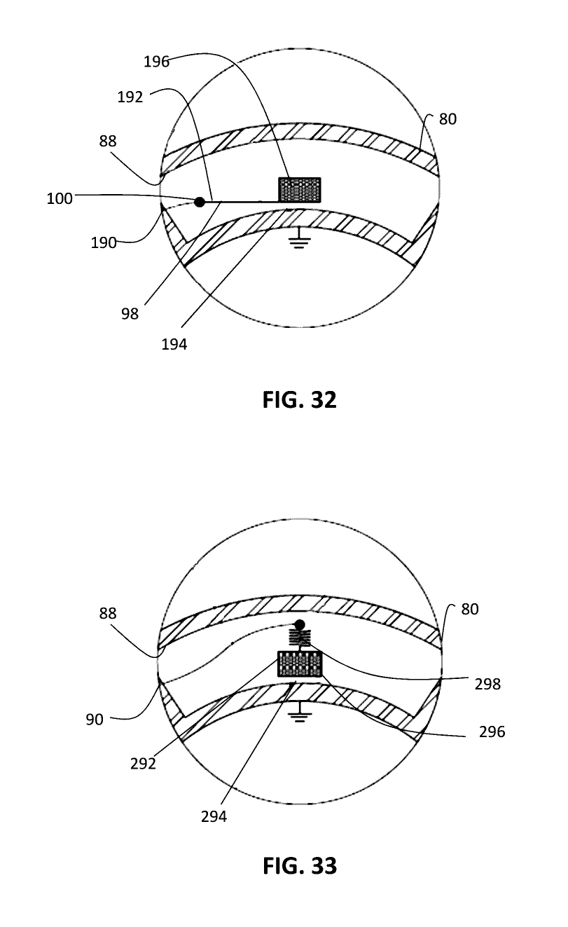

FIGS. 32-33 show alternate embodiments of the normally open switch 94 of FIGS. 28-31. In FIGS. 32-33, an electrically conductive contactor 192,292 of a switch 194,294 has an electrical lead 190,290 and a magnetic portion 196,296 that moves radially to draw the contactor into contact with the interior surface of the sensor cavity 88 to produce the desired electrical signal representative of sensor activation. The contactor 192 of the switch 194 extends in the sensor cavity 88 in a direction perpendicular to the direction of motion of the magnetic portion 196 of the contactor from the first pin 100. In FIG. 32, the bias to maintain the switch 194 in the normally open position is generated from the cantilevered action of the contactor 192. Thus, the contactor 192 of the switch 194 comprises an electrically conductive spring having a proximal end with a cantilever connection to the first pin 100 and a free distal end having the magnetic portion 196. With the contactor proximal end fixed to the pin 100, the contactor distal end extends in the sensor cavity 88 in a direction perpendicular to the direction of motion of the magnetic portion 196 of the contactor. In a normally open position, the contactor distal end and magnetic portion 196 are spaced from the interior surfaces of the cavity 88. When the float 60 comes in close proximity to the distal end of the contactor 192, the magnetic portion 196 of the contactor is drawn toward the float, thereby deflecting the distal end of the contactor into contact with the interior surfaces of the cavity to close the switch and complete the electrical circuit. FIG. 33 shows an alternate embodiment where the contactor 292 is configured to move in a radial direction of motion relative to the outer ring during sensor activation. The biasing member 298 to maintain the switch 294 in the normally open position comprises an electrically conductive coil spring that maintains the magnetic portion 296 of the contactor away from the interior surfaces of the sensor cavity 88. When the float 60 comes in close proximity to the magnetic portion 296 of the contactor, the magnetic portion of the contactor is drawn toward the float and the contactor 292 moves radially against tension of the biasing member 298 to contact the interior surfaces of the sensor cavity 88 to close the switch and complete the circuit.

It should be noted that the embodiments of FIGS. 28-33 show a normally open switch in which the sensor portion 80 of the outer ring is arranged diametrically away from the float 60 in the normal position, and the electrical energy flows only upon sensor activation when the float is in close proximity to the sensor portion. The ring clamp sensor may be provided with an opposite arrangement and the switch may be normally closed. In other words, the ring clamp sensor may be configured with a normally closed switch in which the sensor portion of the outer ring is arranged adjacent to the float in the normal position thereby allowing electrical energy to flow through the circuit, and sensor activation occurs when the float moves away from the sensor portion thereby opening the circuit. The biasing member may be arranged to maintain the switch in the normally closed position.

Completion of the electrical circuit may cause generation of an electrical signal usable for a desired function, which may be used by a controller or other electrical equipment to provide desired indication of a level condition. The level condition may be a fluid fill condition or a fluid drain condition or may be an intermediate condition. The controller or other electrical equipment may be off-the-shelf or customized to provide a variety of desired indications with respect to fluid level. The desired indications may include visible and audible alarms, activation of messages (e.g., wireless), providing signal input to other systems, for instance, starting programs for electrical pumps and other equipment. The ring clamp level sensor may operate on low voltage, and activate relays for operation of other equipment. The ring clamp level sensor, and/or controller or other electrical equipment, may be configured to sense prolonged level conditions thereby eliminating false readings due to incidental or transient sensor activation from mechanical shock (e.g., cleaning, splashing).

In view of the foregoing, it will be seen that the several advantages are achieved and attained. The embodiments were chosen and described in order to best explain the principles of the disclosure and their practical application to thereby enable others skilled in the art to best utilize the principles of the disclosure in various embodiments and with various modifications as are suited to the particular use contemplated. It is intended that all matter contained in the foregoing description or shown in the accompanying drawings shall be interpreted as illustrative rather than limiting.

What is claimed is:

1. A sensor comprising:
an insert configured to be arranged in a bore of a tubular section, the insert having a float with a magnetic material, the float being configured to pivot within the insert; and
an outer ring configured to be arranged around the tubular section, the outer ring having a portion including a switch moveable between open and closed positions, a biasing member configured to maintain the switch in one of the open position and closed positions, and a magnetic portion operatively connected to the biasing member, the magnetic portion of the switch cooperating with the magnetic material in the float in a manner to move the switch between the open and closed positions against the urging of the biasing member based upon a position of the magnetic material of the float relative to the magnetic portion of the switch.

2. The sensor of claim 1 wherein the insert includes an axle about which the float pivots within the insert.

3. The sensor of claim 1 wherein the float is pivotal within the insert to a position adjacent to the magnetic portion of the switch when in the presence of the fluid.

4. The sensor of claim 1 wherein the float comprises a cleaning pad that is configured to abut a viewing window of a fitting comprising the tubular section.

5. The sensor of claim 1 wherein the switch is configured to move from the open position to the closed position when the magnetic material of the float comes into close proximity to the magnetic portion of the switch.

6. The sensor of claim 1 wherein the biasing member is configured to maintain the switch in the closed position until the magnetic material of the float comes into close proximity to the magnetic portion of the switch.

7. A sensor comprising:
an insert configured to be arranged in a bore of a tubular section, wherein the insert has a float with a magnetic material and an axle about which the float is pivotally connected;
plurality of arcuate sections assemblable together around an outer periphery of the tubular section to form an outer ring configured to be mounted around the tubular section, one of the arcuate sections having a switch moveable between open and closed positions, the switch comprising a spring configured to maintain the switch in one of the open and closed positions, and a magnetic portion operatively connected to the switch, the magnetic portion of the switch being configured to cooperate with the magnetic material in the float in a manner to move the switch between the open and closed positions against tension of the spring based upon a position of the magnetic material of the float relative to the magnetic portion of the switch.

8. The sensor of claim 7 wherein the float is pivotal within the insert to a position adjacent to the magnetic portion of the switch when in the presence of the fluid.

9. The sensor of claim 7 wherein the float comprises a cleaning pad that is configured to abut a viewing window of a fitting comprising the tubular section.

10. The sensor of claim 7 wherein the switch is configured to move from the closed position to the open position when the magnetic material of the float comes into close proximity to the magnetic portion of the switch.

11. The sensor of claim 7 wherein the biasing member is configured to maintain the switch in the open position until the magnetic material of the float comes into close proximity to the magnetic portion of the switch.

12. A method comprising:
providing an insert having a float with a magnetic material wherein the float is configured to pivot within the insert;
providing a plurality of arcuate sections assemblable together form a ring, one of the arcuate sections having a switch moveable between open and closed positions, a biasing member configured to maintain the switch in the open position, and a magnetic portion operatively connected to the switch;
inserting the insert in a bore of a tubular section; and
assembling the plurality of arcuate sections together to form a ring around the tubular section and adjacent to the insert with the arcuate section comprising the switch being arranged in the outer ring in a manner such that the magnetic portion of the switch cooperates with the magnetic material in the float in a manner to move the switch between the open position and the closed position against pressure of the biasing member based upon a position of the magnetic material of the float relative to the magnetic portion of the switch.

13. The method of claim 12 wherein the step of assembling the plurality of arcuate sections together to form a ring around the tubular section comprises arranging the section around a fitting with a viewing window.

14. The method of claim 13 wherein the step of inserting the insert includes inserting the insert such that the float abuts the viewing window of the fitting.

15. The method of claim 14 wherein the step of providing the insert includes providing the float with a cleaning pad that engages against the viewing window.

16. The method of claim 15 further comprising manipulating the float to clean the viewing window.

17. The method of claim 12, wherein the step of assembling the plurality of arcuate sections together comprises arranging the arcuate section comprising the switch on the ring such that the magnetic portion of the switch cooperates with the magnetic material in the float in a manner to move the switch from the open position to the closed position against pressure of the biasing member when the magnetic material of the float comes into close proximity to the magnetic portion of the switch.

18. The method of claim 12, wherein the step of assembling the plurality of arcuate sections together comprises arranging the arcuate section comprising the switch on the ring such that the magnetic portion of the switch cooperates with the magnetic material in the float in a manner to move the switch from the closed position to the open position against pressure of the biasing member when the magnetic material of the float comes into close proximity to the magnetic portion of the switch.

19. The method of claim 12, wherein the step of assembling the plurality of arcuate sections together comprises arranging the arcuate section comprising the switch on the ring such that the magnetic portion of the switch cooperates with the magnetic material in the float in a manner to move the switch from the open position to the closed position against pressure of the biasing member when the magnetic material of the float moves away from the magnetic portion of the switch.

20. The method of claim 12, wherein the step of assembling the plurality of arcuate sections together comprises arranging the arcuate section comprising the switch on the ring such that the magnetic portion of the switch cooperates with the magnetic material in the float in a manner to move the switch from the closed position to the open position against pressure of the biasing member when the magnetic material of the float moves away from the magnetic portion of the switch.
